(19) United States
(12) Patent Application Publication
(10) Pub. No.: US 2013/0342916 A1
(43) Pub. Date: Dec. 26, 2013

(54) Zoom Lens and Zoom Control Method Thereof

(71) Applicants: Tzu-Chih Lin, Qionglin Township (TW); Wan-Chih Lin, Hsinchu City (TW); Yu-Cheng Huang, Taichung City (TW)

(72) Inventors: Tzu-Chih Lin, Qionglin Township (TW); Wan-Chih Lin, Hsinchu City (TW); Yu-Cheng Huang, Taichung City (TW)

(73) Assignee: ALTEK CORPORATION, Hsinchu (TW)

(21) Appl. No.: 13/585,311

(22) Filed: Aug. 14, 2012

(30) Foreign Application Priority Data
Jun. 25, 2012 (TW) 101122706

(51) Int. Cl. G02B 15/04

(52) U.S. Cl. 359/694

(57) ABSTRACT

A zoom lens and a zoom control method are disclosed. The zoom lens comprises an image sensing module, a plurality of lens sets, a plurality of reflecting mirrors, a plurality of rotation shafts. The image sensing module senses light beams to generate image signals. The plurality of lens sets respectively have different optical power. The plurality of reflecting minors comprise a movable reflecting mirror and a fixed reflecting minor. The plurality of rotation shafts are coupled the movable reflecting mirror. Therein, the movable reflecting minor is controlled by the plurality of rotation shafts to rotate to a first or a second position, such that the optical paths may be generated when the light beam passes through the lens sets having different optical power and each reflecting minor, and the light beam irradiates into the image sensing module through one of the optical paths.

### CROSS-REFERENCE TO RELATED APPLICATION

This application claims the benefit of Taiwan Patent Application No. 101122706, filed on Jun. 25, 2012, in the Taiwan Intellectual Property Office, the disclosure of which is incorporated herein in its entirety by reference.

### BACKGROUND OF THE INVENTION

1. Field of the Invention

The present invention generally relates to a lens structure, in particular to a zoom lens capable of reducing costs and having simple structure and a zoom control method thereof.

2. Description of the Related Art

A conventional zoom lens is usually to take a stepper motor or an acoustic wave motor to drive lens sets for moving to generate different optical power. However, when the lens sets is moved through mechanical control, the lens sets may easily produce backlash due to mechanical movement. After for a while, a user may not precisely regulate the required lens focusing to cause use inconvenience.

In addition, the stepper motor and the acoustic wave motor may have high costs. The costs may not be reduced during manufacture. Consequently, the production is not easily as well. With respect to demand, designing a zoom lens capable of reducing costs and a zoom control method thereof have become an important issue for use in market applications.

### SUMMARY OF THE INVENTION

Therefore, it is a primary objective of the present invention to provide a zoom lens and a zoom control method thereof to overcome conventional problems.

To achieve the foregoing objective, the present invention provides a zoom lens comprising an image sensing module, a plurality of lens sets, a plurality of reflecting mirrors and a plurality of rotation shafts. The image sensing module sense light beam to generate an image signal. The plurality of lens sets respectively have different optical power. The plurality of reflecting mirrors include a movable reflecting minor and a fixed reflecting mirror. The plurality of rotation shafts are coupled to the movable reflecting mirror. The movable reflecting mirror is controlled by the plurality of rotation shafts to rotate to a first position or a second position such that the light beam passes through the lens sets having different optical power and each reflecting mirror to generate a plurality of optical paths, and the light beam irradiates into the image sensing module through one of the plurality of optical paths.

The invention may further include a housing. The image sensing module, the lens sets, the reflecting mirrors and the rotation shafts may be disposed in the housing.

A lens edge of the movable reflecting minor and a bottom of the housing may be relatively disposed with at least one protrusion portion, and the movable reflecting mirror is stopped at the first position or the second position upon the at least one protrusion portion during rotation.

An inner surface of the housing may have at least one concave-convex portion such that the movable reflecting minor is controlled by the at least one concave-convex portion to position to prevent the light beam irradiating into the image sensing module through the undesired optical paths.

A side surface of one of the reflecting mirrors may be sprayed with light extinction materials to prevent from a glare phenomenon generated by the light beam thereon.

The invention further may include an electromagnetic valve to control the movable reflecting minor to rotate by taking the rotation shafts as centers.

According to the objective of the invention, a zoom control method for a zoom lens is further provided. The zoom control method is applied to the zoom lens. The zoom lens comprises, an image sensing module, a control unit, a plurality of lens sets, a plurality of reflecting mirrors and a plurality of rotation shafts. The zoom control method comprises the following steps: sensing a light beam by the image sensing module to generate an image signal; providing the plurality of lens sets respectively having different optical power; coupling the rotation shafts to the movable reflecting mirror; and controlling the movable reflecting minor to rotate to a first position or a second position through the rotation shafts such that a light beam passing through the lens sets having different optical power and each reflecting mirror to generate a plurality of optical paths and irradiating into the image sensing module through one of the plurality of optical paths.

The foregoing and other objectives and characteristics of the present invention will become apparent with the detailed description of preferred embodiments accompanied with the illustration of related drawings as follows.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1A is a first schematic diagram of a zoom lens of the present invention;

FIG. 1B is a second schematic diagram of a zoom lens of the present invention;

FIG. 2 is a first optical path schematic diagram of a zoom lens in accordance with the present invention;

FIG. 3 is a second optical path schematic diagram of a zoom lens in accordance with the present invention;

FIG. 4 is a third optical path schematic diagram of a zoom lens in accordance with the present invention; and

FIG. 5 is a flowchart of a zoom control method in accordance with the present invention.

### DETAILED DESCRIPTION OF THE PREFERRED EMBODIMENTS

The technical content of the present invention will become apparent by the detailed description of the following embodiments and the illustration of related drawings as follows.

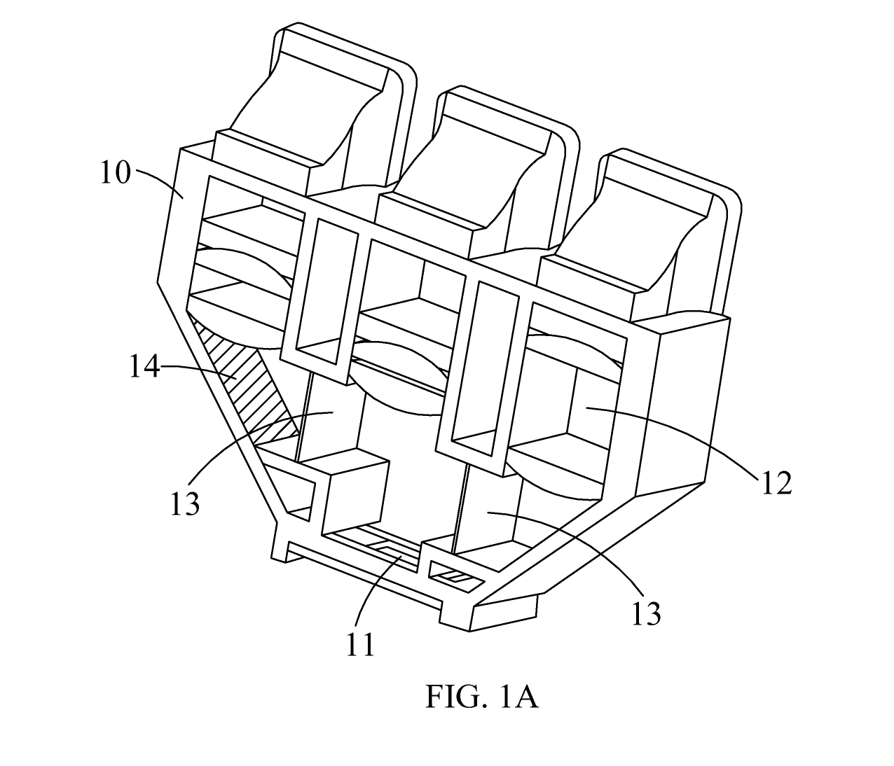

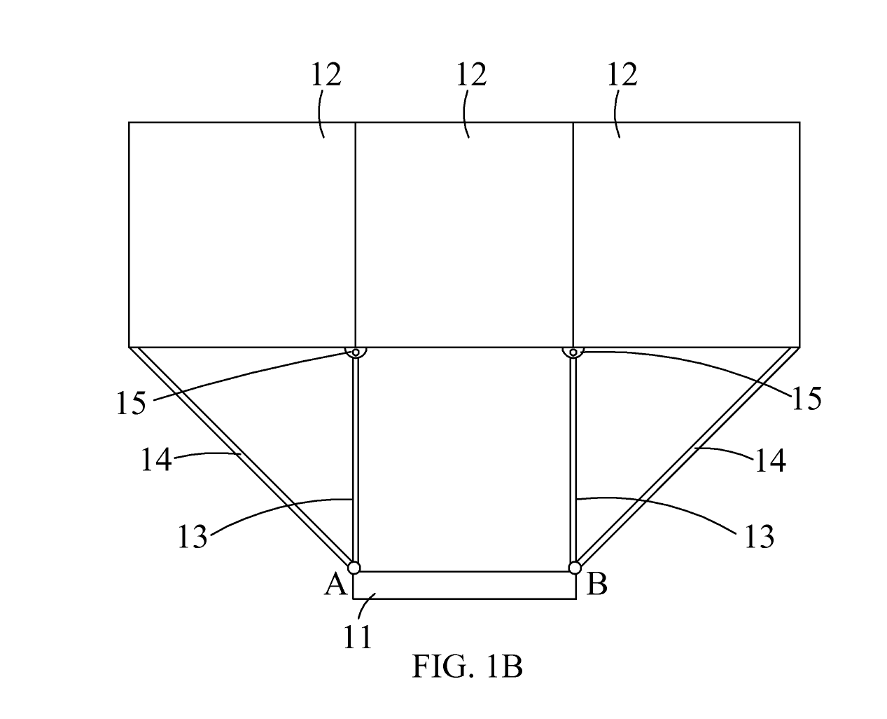

With reference to FIG. 1A and FIG. 1B, a first schematic diagram and a second schematic diagram of a zoom lens according to an invention are depicted. The zoom lens includes a housing 10, an image sensing module 11, a plurality of lens sets 12, a plurality of reflecting mirrors (including movable reflecting mirrors 13 and fixed reflecting mirrors 14) and a plurality of rotation shafts 15. The plurality of lens sets respectively have different optical power as shown in FIG. 1A. The first set of lens set 12 at right side to the third set of lens set 12 at left side respectively have different optical power of 5×, 1× and 3×, wherein the optical power of each lens set 12 may, but not limited to, be disposed upon demands.

As shown in FIG. 1B, the zoom lens comprises the image sensing module 11, the plurality of lens sets 12, wherein the image sensing module 11 may sense light beam to generate image signals. The plurality of lens sets 12, as shown in FIG. 1A, may respectively have different optical power. The inside of the housing below the lens set 12 may be disposed with the fixed reflecting mirrors 14 to reflect light beam penetrating from the lens set 23. The plurality of movable reflecting minors 13 are disposed in the middle of the housing, and the plurality of rotation shafts 15 are coupled to the movable reflecting minors 13. Therefore, the movable reflecting minor 13 may be controlled by the rotation shaft 15 to rotate to a first position A or a second position B such that light beam passes through the lens sets 12 having different power and reflecting minors, and therefore a plurality of optical paths may be generated. And the light beam is irradiated into the image sensing module 11 through one of the optical paths.

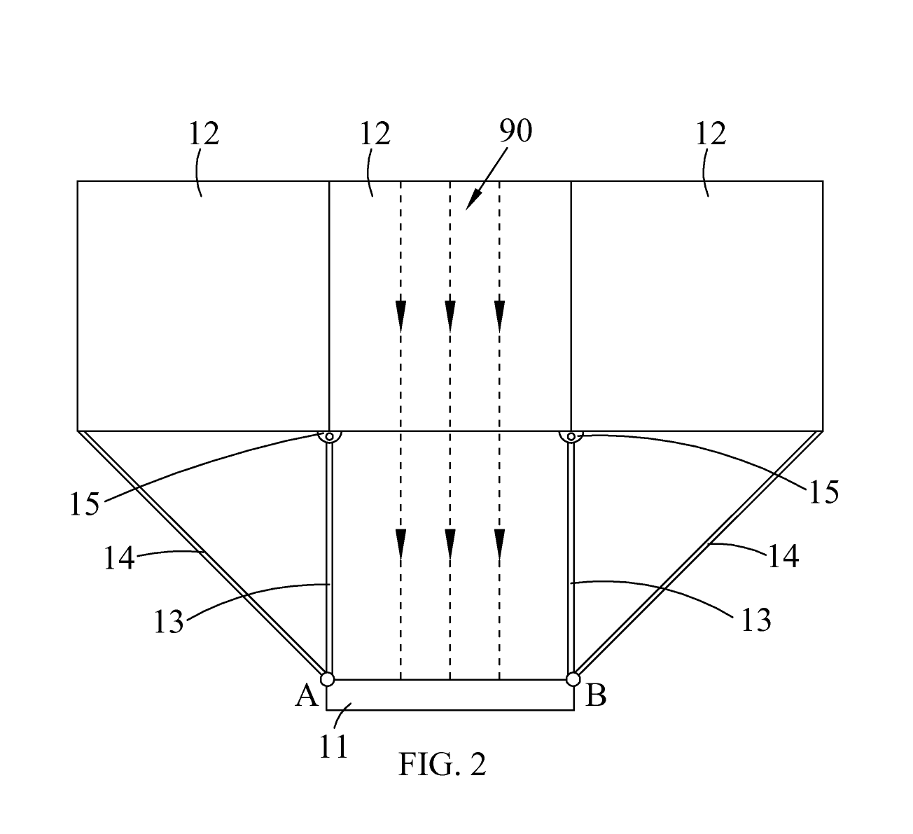

With reference to FIG. 2, a first optical path schematic diagram of a zoom lens according to the invention is depicted. As shown in the figure, two rotation shafts 15 are disposed in the zoom lens to control the rotation of the movable reflecting mirrors 13. Two pieces of the movable reflecting mirrors 13 are respectively positioned to the first position A and the second position B. Accordingly, after the light beam 90 passes through the lens sets 12 at the center, the light beam may be directly irradiated into the image sensing module 11 to generate image signals.

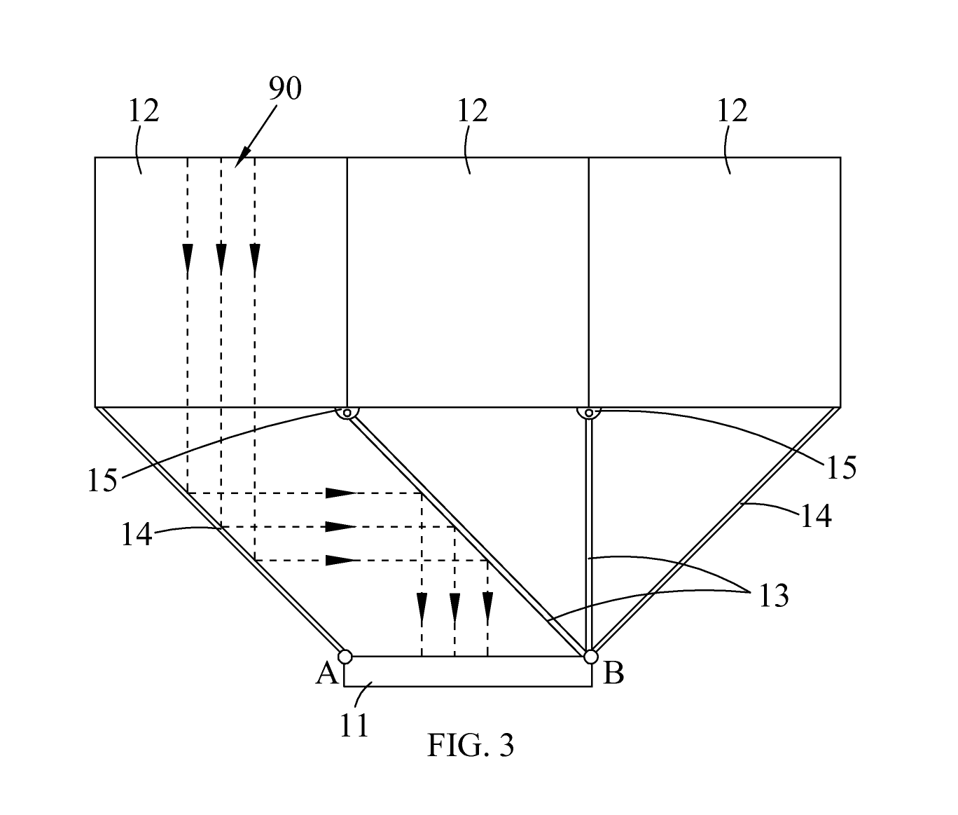

With reference to FIG. 3, a second optical path schematic diagram of a zoom lens according to the invention is depicted. One side of each of the movable reflecting mirrors 13 is positioned at the second position B. When the light beams 90 irradiates into the lens set 12, the light beams 90 at right side and the center will be blocked and would not be able to irradiate into the image sensing module 11. However, after the light beam 90 at left side passes through the lens set 12, the reflection is generated on the fixed reflecting mirror 14 and the movable reflecting minor 13 to irradiate the light beams into the image sensing module 11.

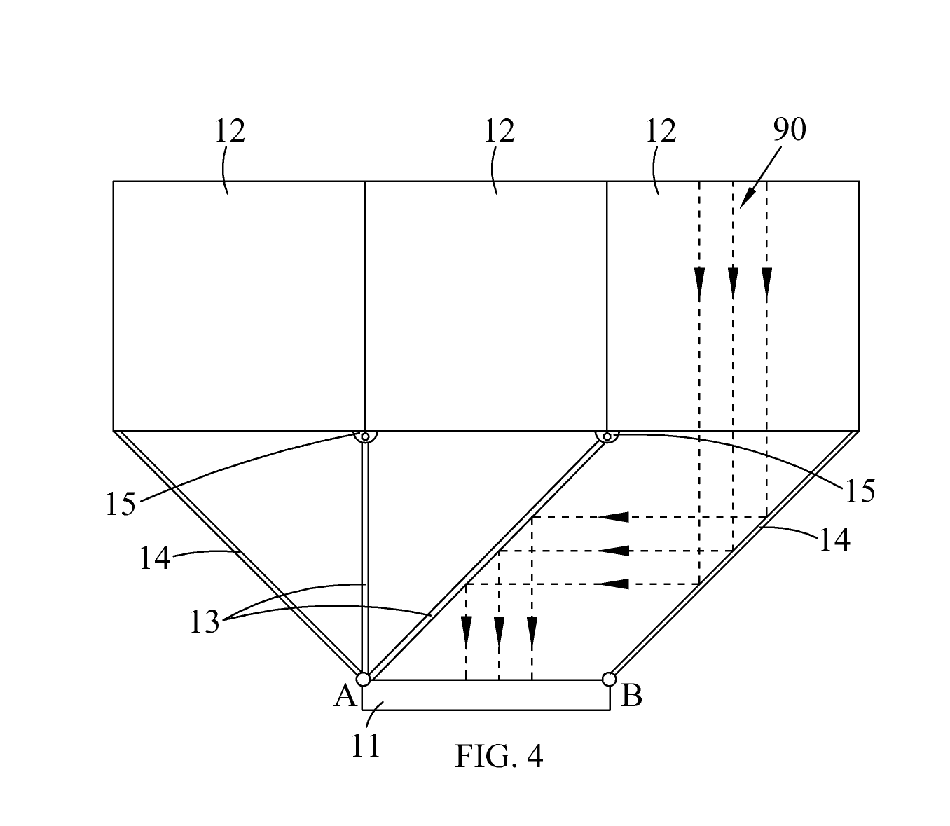

With reference to FIG. 4, a third optical path schematic diagram of a zoom lens according to the invention is depicted. One side of each of the movable reflecting mirrors 13 is positioned at the first position A. When the light beams 90 irradiates into the lens sets 12, the light beams 90 at left side and the center will be blocked and would not be able to irradiate into the image sensing module 11. However, after the light beam 90 at right side passes through the lens set 12, the reflection is generated on the fixed reflecting mirrors 14 and the movable reflecting minors 13 to irradiate the light beams into the image sensing module 11.

It should be noted that the lens edge of the movable reflecting mirrors 13 and the bottom of the housing may be relatively disposed with at least one protrusion portion, and the movable reflecting minors 13 are stopped at the first position A or the second position B upon the at least one protrusion portion during rotation. Alternatively, the inner surface of the housing may also have at least one concave-convex portion so that the movable reflecting mirrors 13 are controlled by the at least one concave-convex portion to perform positioning to prevent from the light beam irradiating into the image sensing module 11 through undesired optical paths.

In addition, one side surface of the movable reflecting minors 13 or the fixed reflecting mirrors 14 may be sprayed with light extinction materials to prevent from a glare phenomenon generated by the light beam thereon. In other words, one side surface of the movable reflecting mirrors 13 and one side surface of the fixed reflecting minors 14 may reflect the light beams 90 such that the light beams 90 directly irradiate into the image sensing module 11 through the reflection.

The zoom lens may include a control unit controlling the movable reflecting minors 13 to rotate by taking the rotation shafts 15 as centers. The control unit may be an electromagnetic valve.

During the process of depicting the zoom lens of the invention, the concept of zoom control method of the zoom lens shown in the invention is depicted at the same time. To clearly depict the invention, a flowchart is provided as the following to describe the zoom control method.

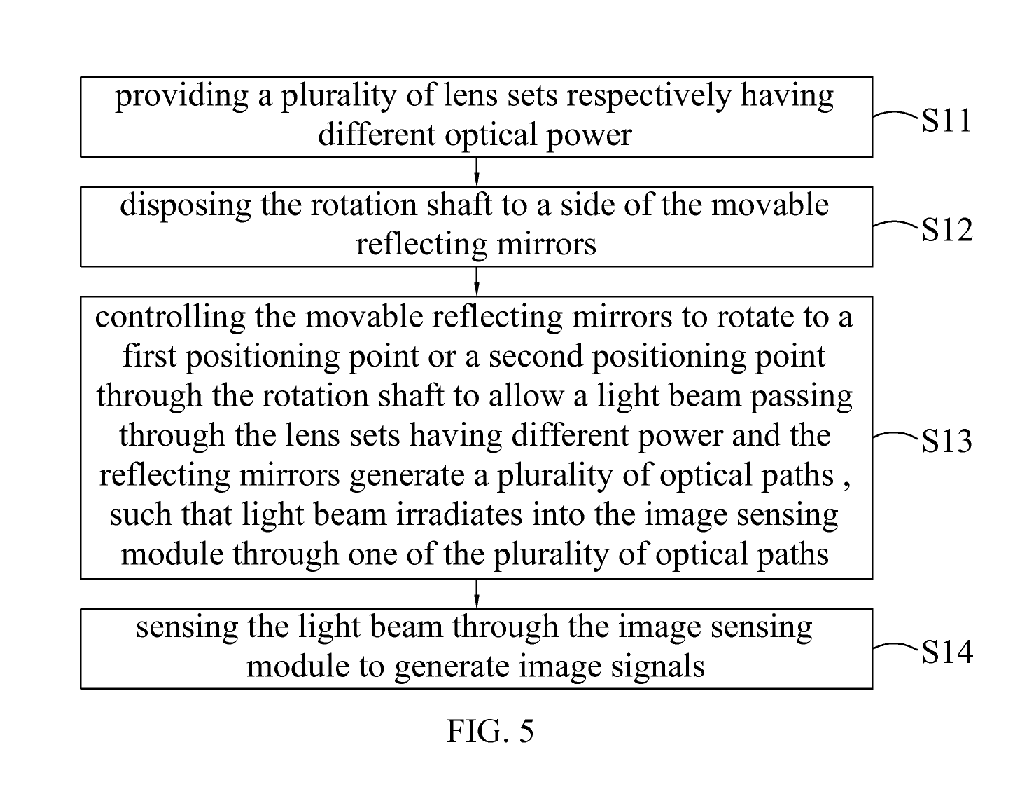

With reference to FIG. 5, a flowchart of a zoom control method according to the invention is depicted. The zoom control method of the invention is applied to the zoom lens.

The detail depiction for the zoom lens has been described in the foregoing paragraphs, and there is no need to describe herein. As shown in FIG. 5, the zoom control method of the zoom lens comprises the following steps:

In step S11, providing a plurality of lens sets respectively having different optical power.

In step S12, coupling the rotation shaft to the movable reflecting minors.

In step S13, controlling the movable reflecting mirrors to rotate to a first position or a second position through the rotation shaft to allow light beam passing through the lens sets having different power and the reflecting mirrors generate a plurality of optical paths, such that the light beam may irradiate into the image sensing module through one of the plurality of optical paths.

In step S14, using the image sensing module to sense the light beam, so as to generate image signals.

The detail description and embodiments of a zoom control method of a zoom lens according to the invention have been descripted in the foregoing paragraphs of the zoom lens, and there is no need to describe herein.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

Therefore, the exemplary embodiments herein merely complete the disclosure and fully provide explanation of embodiments of the invention to the ordinarily skilled person in the art. Accordingly, the claims of the present invention should not be construed as being limited to the embodiments. The invention intended to cover various modifications and equivalent arrangements included within the spirit and scope of the appended claims, and equivalents thereof.

What is claimed is:

1. A zoom lens comprising:
an image sensing module arranged for sensing a light beam to generate an image signal;
a plurality of lens sets respectively having different optical power;
a plurality of reflecting mirrors comprising a movable reflecting mirror and a fixed reflecting mirror; and
a plurality of rotation shafts coupled to the movable reflecting mirror;
wherein the movable reflecting mirror is controlled by the plurality of rotation shafts to rotate to a first position or a second position, such that a plurality of optical paths are generated while the light beam passes through the lens sets having different power and each of the reflecting mirror, and the light beam irradiates into the image sensing module through one of the plurality of optical paths.

2. The zoom lens of claim 1, further comprising a housing, wherein the image sensing module, the lens sets, the reflecting minors and the rotation shafts are disposed in the housing.

3. The zoom lens of claim 2, wherein a lens edge of the movable reflecting minor and a bottom of the housing are relatively disposed with at least one protrusion portion, and the movable reflecting minor is stopped at the first position or the second position upon the at least one protrusion portion during rotation.

4. The zoom lens of claim 2, wherein at least one concave-convex portion is disposed on an inner surface of the housing such that the movable reflecting mirror is controlled by the at least one concave-convex portion to position to prevent from the light beam irradiating into the image sensing module through undesired ones of the optical paths.

5. The zoom lens of claim 1, wherein a side surface of the reflecting minors is sprayed with a light extinction material to prevent from a glare phenomenon generated by the light beam thereon.

6. The zoom lens of claim 1, further comprising an electromagnetic valve, which controls the movable reflecting mirror to rotate by taking the rotation shafts as centers.

7. A zoom control method applied to a zoom lens, the zoom lens comprising an image sensing module, a control unit, a plurality of lens sets, a plurality of rotation shafts and a plurality of reflecting mirrors having a movable reflecting mirror and a fixed reflecting minor, the zoom control method comprising the following steps:
providing the plurality of lens sets, which respectively having different optical power;
coupling the rotation shafts to the movable reflecting minor;
controlling the movable reflecting mirror to rotate to a first position or a second position through the rotation shafts, such that a plurality of optical paths are generated while a light beam passes through the lens sets having different optical power and each of the reflecting mirror, and the light beam irradiates into the image sensing module through one of the plurality of optical paths; and
using the image sensing module to sense the light beam, so as to generate an image signal.

8. The zoom control method of claim 7, further comprising a step of:
providing a housing to dispose the image sensing module, the lens sets, the reflecting minors and the rotation shafts.

9. The zoom control method of claim 8, wherein a lens edge of the movable reflecting minor and a bottom of the housing are relatively disposed with at least one protrusion portion, and the movable reflecting minor is stopped at the first position or the second position upon the at least one protrusion portion during rotation.

10. The zoom control method of claim 8, wherein at least one concave-convex portion is disposed on an inner surface of the housing, such that the movable reflecting minor is controlled by the at least one concave-convex portion to prevent from the light beam irradiating into the image sensing module through undesired ones of the optical paths.

11. The zoom control method of claim 7, further comprising steps of:
spraying a light extinction material on a side surface of one of the reflecting minors to prevent from a glare phenomenon generated by the light beam thereon.

12. The zoom control method of claim 7, further comprising a step of:
reflecting the light beam through a side surface of the movable reflecting mirror and a side surface of the fixed reflecting mirror to irradiate into the image sensing module.

13. The zoom control method of claim 7, wherein the control unit is an electromagnetic valve.
